(19) United States
(12) Patent Application Publication
(10) Pub. No.: US 2007/0157702 A1
(43) Pub. Date: Jul. 12, 2007

(54) Humidity indicator labels

(76) Inventor: Masatami Hamada, Osaka (JP)

Correspondence Address: MERCHANT & GOULD PC, P.O. BOX 2903, MINNEAPOLIS, MN, 55402-0903, US

(21) Appl. No.: 11/329,965

(22) Filed: Jan. 10, 2006

(51) Int. Cl. G01N 19/10; G01D 21/00; B65D 85/00

(52) U.S. Cl. 73/29.04; 206/459.1; 116/206

(57) ABSTRACT

The present invention relates to a humidity indicator label and to a desiccant packet with the humidity indicator label coupled to it.

### FIELD OF THE INVENTION

The present invention relates to a humidity indicator label and to a desiccant packet with the humidity indicator label coupled to it.

### BACKGROUND

A desiccant is a substance, such as silica gel, montmorillonite clay and/or calcium chloride, that readily absorbs high amounts of water, relative to its own weight, and is therefore used as a drying agent. Packets filled with desiccant are commonly placed with items that are easily degraded or damaged by moisture in order to protect such items from ambient humidity.

These desiccant packets are manufactured separately from the items they are subsequently used to protect from humidity. Consequently, a desiccant packet may be exposed to and absorb sufficient humidity to be totally consumed prior to its intended use. Furthermore, conventional desiccant packets do not exhibit any change in appearance as they absorb moisture and, consequently, it is not possible to visually discern when the desiccant packet has been fully consumed.

Sometimes, items are packaged with a desiccant packet and a separate paper humidity indicator card. Chemical indicator spots on these paper cards change color when the ambient humidity exceeds certain levels. Over time, moisture will cause these chemical indicators to diffuse through the paper, changing the concentration and consequently giving false readings. Furthermore, since an indicator card is not combined with a desiccant packet until both are placed with the item to be protected, the card cannot provide any indication of the condition of the desiccant packet at implementation. Also, desiccant packets are often used without the addition of a humidity indicator card. In these cases, it is not readily ascertainable if the desiccant packet is functioning as intended.

There remains a need, therefore, for a humidity indicator label that can be effectively coupled to a desiccant packet at the time of manufacture and/or that can indicate the condition of the desiccant packet before and during use.

### SUMMARY

The present invention relates to a humidity indicator label and to a desiccant packet with the humidity indicator label coupled to it.

In an embodiment, the present invention includes a humidity indicator label including a plastic substrate, paper comprising humidity indicator material, and adhesive. The plastic substrate includes first and second sides. The paper comprising humidity indicator material is disposed on the first side of the plastic substrate. The adhesive is disposed on the second side of the plastic substrate. The present humidity indicator label can be adhered to a desiccant packet.

In an embodiment, the present invention includes a desiccant packet. The present desiccant packet can include a sealed packet containing a desiccant material and the present humidity indicator label adhered to the outside of the sealed packet.

The present invention also includes methods of making and using the present humidity indicator label.

### BRIEF DESCRIPTION OF THE FIGURES

FIGS. 1 and 2 schematically illustrate embodiments of the present humidity indicator label.

FIGS. 3 and 4 schematically illustrate embodiments of the present humidity indicator label including embodiments of segmented humidity indicators.

FIGS. 5 and 6 schematically illustrate embodiments of the present humidity indicator coupled to an embodiment of a desiccant packet.

### DETAILED DESCRIPTION

### The Present Humidity Indicator Label

The present invention relates to a humidity indicator label. The present label provides a layered construction that can be coupled to a desiccant packet. The layered construction can couple the present label to the desiccant packet. The layered construction can isolate the present label from the desiccant and/or water in the packet. For example, the layered construction can reduce drying of the label by dry desiccant compared to a label that is on the packet but not isolated from the desiccant. For example, the layered construction can reduce wetting of the label by wet desiccant compared to a label that is on the packet but not isolated from the desiccant. The present invention also relates to a desiccant package including the present humidity indicator label.

In an embodiment, the present label is coupled to the desiccant packet when the desiccant is manufactured, dry, and ready to absorb water from the surroundings. The labeled desiccant packet can then be sealed in a container, for example, a container that is impermeable to or only slightly permeable to water. The container including one or more labeled desiccant packets can then be stored, transported, and/or routed through one or more distributors before reaching the user. Humidity may enter the container, for example, if the container is damaged or defective. The humidity indicator label(s) will inform the user whether the humidity in the container of labeled desiccant packet(s) exceeds a desired level. Higher than desired humidity will consume more than an acceptable portion of the desiccant in the packet. The user can then reject those containers of desiccant packet that are unacceptable. If the container includes a transparent window, the user can view the humidity indicator label without opening the container. Thus, the user can determine whether the labeled humidity indicator packets were exposed to unacceptable humidity without opening the container.

In an embodiment, the labeled desiccant packet (e.g., an acceptably dry labeled desiccant packet) can be removed from its container and packaged with goods, which are to be protected from moisture. The package containing the goods can be impermeable to or only slightly permeable to water. The package containing goods can be in an outer package impermeable to or only slightly permeable to water. The packaged goods including one or more labeled desiccant packets can then be stored, transported, and/or routed through one or more distributors before reaching the customer. Humidity may enter the package, for example, if the package is damaged or defective. The humidity indicator label(s) will inform the customer whether the humidity in the package of goods exceeds a desired level. Higher than desired humidity consumes more than an acceptable portion of the capacity of the desiccant in the packet to absorb water before becoming fully saturated. The receiver of the goods (e.g., a customer) can then reject those packages of goods that are unacceptable. If the package includes a transparent window, the customer can view the humidity indicator label without opening the package. Thus, the customer can determine whether the goods are exposed to unacceptable humidity without opening the container.

In an embodiment, the method employing the present humidity indicator label includes providing or obtaining a desiccant packet to which the present label was coupled when the desiccant was dry. For example, the method can include obtaining from a supplier or manufacturer a desiccant packet in a sealed container and labeled with a humidity indicator label. The method can include viewing the labeled desiccant packet to determine whether the sealed container includes unacceptable humidity. An acceptable labeled desiccant packet can be packaged with goods. The goods packaged with the labeled desiccant packet can be provided to another, e.g., a customer.

### Embodiments of a Humidity Indicator Label

The present invention relates to a humidity indicator label. In an embodiment, the present label can include a material including a humidity indicator, a plastic substrate, and adhesive. The plastic substrate can have first and second sides. The material including a humidity indicator can be disposed on the first side of the substrate. The adhesive can be disposed on the second side of the plastic substrate. The adhesive can be effective for coupling the humidity indicator label to an object, such as a packet containing desiccant. The material including a humidity indicator can be or include paper including (e.g., impregnated with) humidity indicator material.

In an embodiment, the material including a humidity indicator can be configured to provide an indication (e.g., a color change) when the amount of humidity to which it is exposed exceeds a predetermined level.

The material including a humidity indicator can be configured to provide portions that change color at different predetermined amounts of humidity. For example, the humidity indicator (e.g., paper including humidity indicator material) can be configured as a plurality of segments. Each segment can include humidity indicator material configured to change color at a different level of humidity than the other segment(s). Segments of humidity indicator (e.g., paper including humidity indicator material) can be configured as a strip. Segments of humidity indicator (e.g., paper including humidity indicator material) can be configured as sectors of a circle. Segments of humidity indicator (e.g., paper including humidity indicator material) can be arranged from low to high concentration of the humidity indicator material or from low to high level of humidity indicated.

The segments can be on the plastic substrate and separated from one another. That is, the present humidity indicator label can include a space between one or more (or all) of the segments. Although not limiting to the present invention, it is believed that the space prevents humidity indicator material from diffusing into a larger portion of the paper, which decreases the concentration of the material, and changes the humidity at which the color change occurs.

One or more of the segments can include printed on them the humidity level (e.g., the percentage of relative humidity (% RH) at which it changes color. Alternatively, the humidity level can be printed on the plastic substrate adjacent the segment.

### Humidity Indicator

The material including a humidity indicator can be any of a variety of materials that can provide a perceptible visual signal in response to exposure to a predetermined amount of humidity. A variety of known materials can provide a perceptible visual signal, such as a color change, in response to exposure to humidity. The amount and/or type of material can be selected to provide a visual signal in response to exposure to a preselected amount of humidity, e.g., in a sealed container or package. Suitable materials include cobalt chloride, for example, paper including (e.g., impregnated with) cobalt chloride. The present humidity indicator material can include cobalt chloride and polyethylene glycol, for example, paper impregnated with a composition including cobalt chloride and polyethylene glycol. Suitable humidity indicator materials include pH indicator and suitable acid, for example, paper including (e.g., impregnated with) pH indicator and suitable acid.

The humidity indicator material can be present in a type or in an amount to provide a color change at a preselected level of humidity. Any of a variety of known humidity indicator materials can be employed in the label of the present invention.

### Cobalt Chloride

According to the present invention, the cobalt chloride can be present in a concentration that provides a color change at a preselected level of humidity. A humidity indicator material including cobalt chloride and polyethylene glycol provides a color change at a higher amount of humidity than cobalt chloride without polyethylene glycol. Increasing the amount of polyethylene glycol, and therefore reducing the relative concentration of cobalt chloride, increases the amount of humidity required to induce the color change. The cobalt chloride and polyethylene glycol can be present in relative concentrations to provide a color change at a preselected level of humidity.

When cobalt chloride is exposed to water, a distinct color change from blue to pink is observed. Although not limiting to the present invention, it is believed that the mechanism for this color change depends on the coordination around the Co²⁺ metal ion. In the anhydrous form, Co²⁺ exists as the tetrahedral [CoCl₄]²⁻ complex, which is deep blue in color. When this complex is exposed to water, an intermediate purple-colored complex is formed. When completely saturated with water, Co²⁺ exists as the octahedral complex [Co(H₂O)₆]²⁺ form, which is pink. Suitable cobalt chloride compositions for use as a humidity indicator material include those described in U.S. Military Specification MIL-I-8835 (1984).

This change in color of blotting paper including cobalt chloride (or cobalt chloride diluted with polyethylene glycol) can be directly correlated to changes in relative humidity, and the humidity indicator label therefore provides a simple method for monitoring the relative humidity of the surroundings of the label. The concentration of cobalt chloride in paper can be selected to provide a color change, for example, at about 20% relative humidity, at about 40% relative humidity, and/or at about 60% relative humidity. The indicator label can be configured to provide a color change within a few percent of each of these amounts. Although not limiting to the present invention, it is believed that the color change can occur at a preselected relative humidity to an accuracy of about ±1% relative humidity. A label including a segment changing color at about 20% relative humidity can indicate a dry environment. A label including a segment changing color at 60% humidity can indicate a high humidity. A label can include both such segments, and even additional segments, for example, indicating intermediate levels of humidity.

Solutions of cobalt chloride readily impregnate paper, such a blotting paper or unsized absorbent fiber paper. Typically, the blotting paper is impregnated with a composition including about 0.5 to about 2.0 wt-% cobalt chloride (see, e.g., U.S. Pat. No. 2,460,071). Modifying the amount of cobalt chloride impregnated into paper (e.g., unsized fiber paper) can be accomplished by modifying the concentration of cobalt chloride in the solution used to treat the paper. A higher concentration of cobalt chloride in the solution results in a larger quantity of cobalt chloride in the paper and a color change at a lower level of relative humidity.

Modifying the amount of cobalt chloride impregnated into paper (e.g., unsized fiber paper) can be accomplished by treating the paper with a mixture of polyethylene glycol, water, and cobalt chloride. As the proportion of polyethylene glycol increases and the relative concentration of cobalt chloride decreases, the cobalt chloride color change (blue to pink) occurs at a higher relative humidity. Suitable polyethylene glycol (PEG) includes PEG with a molecular weight of about 200 to about 35,000, which is commercially available.

### Acid and Dye

A humidity indicator material including pH indicator (e.g., an indicator dye) and, optionally, acid can provide a color change at a predetermined level of humidity. Changing the relative concentration of pH indicator and acid can change the humidity level required to induce the color change. Depending on the amount and type of acid added to the pH solution, one can obtain pH indications at various pH ranges, and therefore various ranges of indicated percent relative humidity. Suitable acids to regulate pH are organic acids, such as acetic acid, formic acid, benzene-sulfonic acid, malic acid, citric acid. The humidity absorption property of un-sized paper can also be increased by adding one or more deliquescent salts such as lithium chloride, calcium chloride, sodium bromide, or potassium perchlorate.

The table below shows pH indicators known to be useful as humidity indicators. The present humidity indicator label can include combinations of the listed pH indicators.

| Name of pH indicator | Low pH | High pH | Color change |
|---|---|---|---|
| Neutral red | 0 | → 1.5 | dark blue → red |
| Crystal violet | 1.5 | → 3.2 | blue → violet |
| Brilliant green | 0 | → 2.0 | yellow → green |
| Methyl violet | 0.1 | → 1.5 | yellow → blue |
| Methyl violet | 1.5 | → 3.2 | blue → violet |
| Methyl orange | 3.1 | → 4.5 | red → yellow |

A pH indicator is a substance which changes color with a change in pH. Although not limiting to the present invention, such indicators are usually weak acids or bases that ionize in solution to produce their conjugate bases or acids. A weak acid indicator (HIn) and its conjugate base (In⁻) exist in the following equilibrium:

HIn(aq)+H₂O⇄H₃O⁺+In⁻(aq)

The weak acid and conjugate base have different colors. At low pH, the concentration of H₃O⁺ is higher; the equilibrium above shifts to the acid (or HIn) side, and the color of the weak acid is seen. As the pH increases, the concentration of H₃O⁺ decreases, shifting the equilibrium to the conjugate base and changing the color of the solution accordingly. Although not limiting to the present invention, it is believed that as the water in the label increases, the pH increases, and the equilibrium above is shifted to the conjugate base side. Therefore, this type of indicator agent senses changes in humidity by sensing changes in paper pH, corresponding to the change in the percentage of water content in the unsized paper. Similarly, the addition of an organic acid to the pH indicator changes the pH and influences the equilibrium above. Depending on the amount and type of acid added to the pH indicator, color change reactions (i.e. pH indications) can be obtained at various pH values, and therefore, at various values of relative humidity.

### Paper

The present label can include any of a variety of types of paper as a base for the humidity indicator material. Paper is hygroscopic in varying degrees. Types of paper suitable for use in humidity indicator labels are known. Suitable paper includes unsized paper, absorbent paper, fiber paper, or unsized absorbent fiber paper. In an embodiment, the paper (e.g., unsized absorbent fiber paper) has a weight of about 25 to about 70 g/m². In an embodiment, the paper includes fibers (e.g., long fibers) from coniferous trees. In an embodiment, the paper is impregnated with the humidity indicator material.

Although not limiting to the present invention, it is believed that un-sized paper does not compromise the impregnation of the paper by the humidity indicator (e.g., cobalt chloride) solution or its ability to indicate humidity. Although not limiting to the present invention, it is believed that if the paper weighs more than 70 g/m², it takes more than acceptable time for humidity to spread through the paper, which can unacceptably delay humidity sensing. Although not limiting to the present invention, it is believed that if the paper weighs less than 25 g/m², the cobalt chloride or pH indicator agents may not be sufficiently impregnated into the paper and the paper may not be sufficiently strong. Although not limiting to the present invention, it is believed that paper made from the long fibers of coniferous trees advantageously does not fluff and has good moist strength.

### Plastic Substrate

The plastic substrate can be any of a variety of plastics suitable for coupling to a humidity indicator and to an adhesive. Such plastics include known thermoplastics. For example, the thermoplastic substrate can include or be polyethylene, polypropylene, polyvinyl acetate, or ethylene vinyl acetate copolymer. In an embodiment, the plastic substrate includes or is a thermoplastic polymer film. In an embodiment, the plastic substrate is transparent or translucent. In an embodiment, the thermoplastic polymer film mounts the indicator paper onto adhesive paper, forming an indicator label that easily adheres to another surface.

As used herein, the term “thermoplastic” refers to a plastic that can once hardened be melted and reset. Suitable thermoplastics include polyamide, polyolefin (e.g., polyethylene, polypropylene, poly(ethylene-copropylene), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymerization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like. Suitable copolymers of alpha-olefins include ethylene-propylene copolymers, ethylene-hexylene copolymers, ethylene-methacrylate copolymers, ethylene-methacrylate copolymers, copolymers and mixtures of these materials, and the like. Although not limiting to the present invention thermoplastic polymers are generally not highly crosslinked, and have low melting and boiling points, low strength, and low ductility. In certain embodiments, suitable thermoplastics include polyethylene, polypropylene, polyvinyl acetate, ethylene vinyl acetate copolymer, copolymers and mixtures of these materials, and the like.

### Adhesive

The adhesive can be any of a variety of known adhesives suitable for coupling to a humidity indicator label to an object, such as a desiccant packet. For example, the adhesive can include adhesive on a paper or polymeric backing or double-sided adhesive transfer tape and peel off paper or polymeric backing. In an embodiment, the adhesive is transparent or translucent. In an embodiment, the plastic substrate and the adhesive are transparent or translucent.

Suitable adhesive papers or films include those made from pulp based paper such as coated (art) paper, or polypropylene backing, such as “Yupo” Paper by Yupo Corporation, Japan, polyester backing, such as the Pink Coated Paper by Nisshin Spinning Inc., Japan, or other adhesive papers or films. Suitable adhesives include double lined adhesive transfer tape. A double lined adhesive transfer tape can be configured so that only the adhesive layer remains after the “peel strips” are removed from both sides of the adhesive material. Suitable adhesive transfer tapes include the 3M product with the tradename 8132LE with adhesive with the tradename 300LSE. The adhesive layer may include aluminum foil provided that one side is coated with a suitable adhesive. In certain embodiments, the adhesive has low volatility, does not significantly react with the humidity indicator material, and/or does not cause corrosion on metal parts that it may contact.

Any of a variety of other materials or mechanisms can be employed for coupling the label to the packet. For example, Velcro can be employed rather than an adhesive. Coupling can include a weld, stitching, a rivet, a plastic tab (such as those employed to couple labels to garments), a staple, a pin, or the like.

### Making the Present Humidity Indicator Label

The present invention relates to a method of making a humidity indicator label. The method can include providing a plastic substrate, coupling a humidity indicator to one side of the plastic substrate, and applying adhesive to a second side of the plastic substrate. The humidity indicator and adhesive can be those described herein.

### Embodiments of a Labeled Desiccant Packet

The present invention relates to a labeled desiccant packet. In an embodiment, the present labeled desiccant packet includes the present humidity indicator label coupled to (e.g., adhered to) the exterior of a desiccant packet. The desiccant packet can be any of a variety of known desiccant packets. The packet can be made of any of a variety of conventional materials for desiccant packets and the desiccant can be any of a variety of conventional desiccants (e.g., silica gel, montmorillonite clay, calcium chloride, and the like). The desiccant packet can be sealed to retain the desiccant in the packet.

In an embodiment, the present labeled desiccant packet includes a sealed packet containing a desiccant material and a humidity indicator label coupled to the outside of the sealed packet. The humidity indicator label can include a plastic substrate comprising first and second sides; paper comprising humidity indicator material and disposed on the first side of the plastic substrate; and adhesive disposed on the second side of the plastic substrate. The adhesive is adhered to the desiccant packet, forming the labeled desiccant packet.

The configuration of the present humidity indicator label can isolate the humidity indicator material (e.g., paper including humidity indicator material) from the desiccant in the packet. For example, if paper including hydroscopic material were in direct contact with the desiccant packet, the desiccant could transfer water to or from the humidity indicator material. This may result in the indicator providing an incorrect reading of the amount of humidity in the environs of the packet. The present humidity indicator label employs the adhesive and the plastic substrate to isolate the humidity indicator material from the desiccant in the packet.

### Illustrated Embodiments

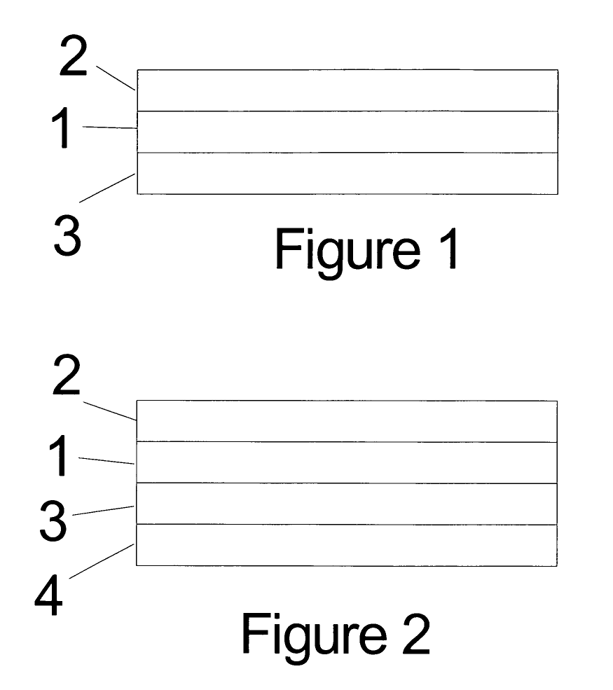

FIGS. 1 and 2 schematically illustrate embodiments of the present humidity indicator label. The illustrated embodiments includes plastic layer 1 as an embodiment of the present plastic substrate, indicator layer 2 as an embodiment of the present humidity indicator, and adhesive layer 3 as an embodiment of the present adhesive. The embodiment illustrated in FIG. 2 also includes backing layer 4 as an embodiment of a backing for the adhesive. The backing layer 4, which can be a peel strip, is removed to adhere the label to a desiccant packet.

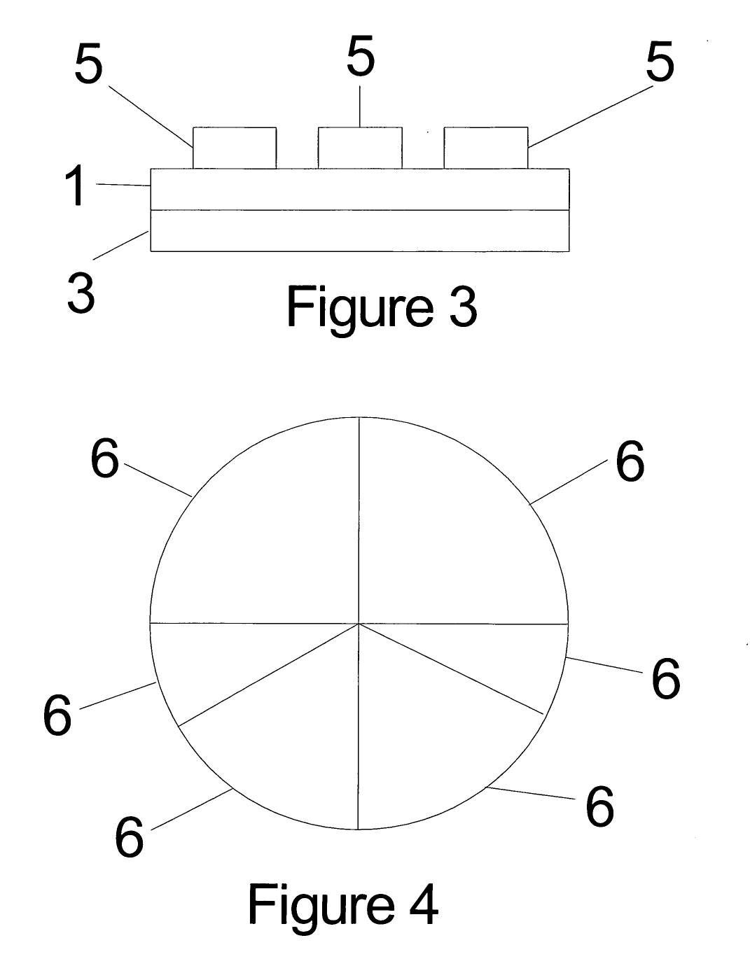

FIGS. 3 and 4 schematically illustrate embodiments of the present humidity indicator label including embodiments of segmented humidity indicators. FIG. 3 illustrates a embodiment of the present humidity indicator including a plurality of humidity indicator pads 5. FIG. 3 illustrates a embodiment of the present humidity indicator including a plurality of indicator wedges 6. Each pad or wedge can be configured to change color at a different level of relative humidity.

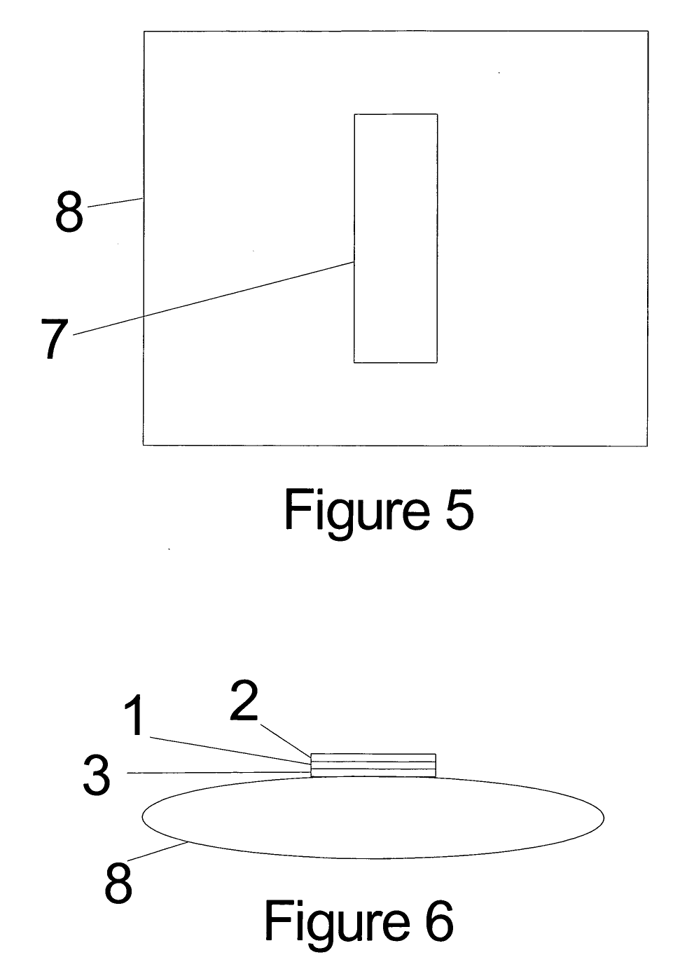

FIGS. 5 and 6 schematically illustrate embodiments of the present humidity indicator coupled to an embodiment of a desiccant packet. FIG. 5 schematically illustrates a desiccant bag 8 including on its exterior humidity indicator strip 7, which is an embodiment of the present humidity indicator label. This embodiment of humidity indicator strip 7 can include a plurality of segments. In the illustrated embodiment, the segments are separated from on another. FIG. 6 schematically illustrates a side view of the desiccant bag 8 with coupled to it an embodiment of the humidity indicator label as illustrated in FIG. 1.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A humidity indicator label, comprising:
a plastic substrate comprising first and second sides;
paper comprising humidity indicator material and disposed on the first side of the plastic substrate; and
adhesive disposed on the second side of the plastic substrate.

2. The humidity indicator label of claim 1, wherein the humidity indicator material comprises cobalt chloride.

3. The humidity indicator label of claim 2, wherein the humidity indicator material further comprises polyethylene glycol and water;
the relative concentrations of cobalt chloride and polyethylene glycol being selected to provide a color change at a preselected level of humidity.

4. The humidity indicator label of claim 1, wherein the humidity indicator material comprises pH indicator and acid;
the relative concentrations of pH indicator and acid being selected to provide a color change at a preselected level of humidity.

5. The humidity indicator label of claim 1, wherein the humidity indicator material impregnates the paper.

6. The humidity indicator label of claim 1, wherein the paper comprises unsized absorbent fiber paper.

7. The humidity indicator label of claim 6, wherein the paper comprises a weight of about 25 to about 70 g/m².

8. The humidity indicator label of claim 6, wherein the paper comprises fibers from coniferous trees.

9. The humidity indicator label of claim 1, wherein the plastic substrate comprises a thermoplastic film.

10. The humidity indicator label of claim 9, wherein the thermoplastic comprises polyethylene, polypropylene, polyvinyl acetate, or ethylene vinyl acetate copolymer.

11. The humidity indicator label of claim 1, wherein the adhesive comprises adhesive on a backing.

12. The humidity indicator label of claim 1, wherein adhesive comprises double-sided adhesive transfer tape and peel off backing.

13. The humidity indicator label of claim 1, wherein the paper comprising humidity indicator material is configured as a plurality of segments; each segment comprising humidity indicator material configured to change color at a different level of humidity.

14. The humidity indicator label of claim 13, wherein the segments are configured in a linear array.

15. The humidity indicator label of claim 13, wherein each segment is configured as a sector of a circle.

17. The humidity indicator label of claim 13, wherein the segments are arranged from low to high concentration of the humidity indicator material.

18. The humidity indicator label of claim 1, wherein the plastic substrate and adhesive are transparent or translucent.

19. The humidity indicator label of claim 1, further comprising a desiccant packet, the humidity indicator label being coupled to the desiccant packet.

20. A labeled desiccant packet, comprising:
a sealed packet containing a desiccant material; and
a humidity indicator label coupled to the outside of the sealed packet;
the humidity indicator label comprising:
a plastic substrate comprising first and second sides;
paper comprising humidity indicator material and disposed on the first side of the plastic substrate; and
adhesive disposed on the second side of the plastic substrate.

21. A method of using a humidity indicator label, comprising:
obtaining from a supplier or manufacturer a desiccant packet labeled with a humidity indicator label;
packaging the labeled desiccant with goods to be provided to another.

22. A method of making a humidity indicator label, comprising:
impregnating a paper with a humidity indicator material;
coupling the impregnated paper to a first side of a plastic substrate; and
applying an adhesive to a second side of the plastic substrate.
